(19) United States
(12) Patent Application Publication
(10) Pub. No.: US 2011/0125875 A1
(43) Pub. Date: May 26, 2011

(54) TERMINAL MANAGEMENT SYSTEM, TERMINAL MANAGEMENT SERVER, AND TERMINAL DEVICE

(75) Inventor: Kazuki MATSUI, Kawasaki (JP)

(73) Assignee: FUJITSU LIMITED, Kawasaki-shi (JP)

(21) Appl. No.: 12/950,382

(22) Filed: Nov. 19, 2010

(30) Foreign Application Priority Data
Nov. 20, 2009 (JP) 2009-265369

(51) Int. Cl. G06F 15/173; G06F 15/16

(52) U.S. Cl. 709/219; 709/223

(57) ABSTRACT

A terminal management server in a terminal management system, the server includes, a command check reception unit to communicate with a plurality of terminal devices, a command registration management unit to store a command in a command management table associated with identification information for a terminal device, a command check reception unit to receive identification information for one terminal device or a plurality of terminal devices and an acquisition request for a command, transmitted from one terminal device, a command registration unit to determine whether or not there is a command in the command management table, when an acquisition request for the identification information and the command is received, and a command transmission unit to transmit the command to a terminal device that is a transmission source of the acquisition request when it is determined that there is the command in the command management table.

### CROSS-REFERENCE TO RELATED APPLICATIONS

This application is based upon and claims the benefit of priority of the prior Japanese Patent Application No. 2009-265369, filed on Nov. 20, 2009, the entire contents of which are incorporated herein by reference.

### FIELD

The embodiments discussed herein relate to a terminal management system, a terminal management device, and a terminal device, which manage a lock and unlock of a terminal device.

### BACKGROUND

In recent years, awareness of the security of terminal devices such as personal computers (PCs) or the like has increased. For example, when a notebook PC is taken out of a company, and the PC is lost or stolen, information about a company stored in a hard disk in the PC may be discovered and leaked. Therefore, there is a company that prohibits a notebook PC from being taken out of the workplace.

On the other hand, with respect to mobile phones, interest in the security thereof is also high in a similar way as with PCs. With respect to business-use mobile phones used in companies, there are also risks that the business-use mobile phones may be lost or stolen. However, with respect to mobile phones, as illustrated in, for example, Japanese Laid-open Patent Publication No. 2008-48129, a communication carrier provides a terminal management service for mobile phones, in which terminal lock or data deletion is remotely performed.

For a mobile phone, the framework of a short message service (SMS) is typically provided in which a notice is sent in real time using a communication network provided by a communication carrier, and, using the framework, a control operation can be executed remotely and immediately within a radio wave range.

### SUMMARY

According to an aspect of an embodiment, a terminal management system including a terminal management server and a terminal device includes a terminal management server including a communication unit configured to communicate with a plurality of terminal devices, a command registration unit configured to store a command in a command management table associated with identification information for a terminal device, the command being used to restrict a function of the terminal device or cancel a restriction on a function of the terminal device, a command check reception unit configured to receive identification information for a terminal device and an acquisition request for a command, transmitted from the terminal device, and configured to determine whether there is a command stored in the command management table, the command being associated with the received identification information for the terminal device, and a command transmission unit configured to transmit the command to a terminal device that is a transmission source of the acquisition request when it is determined that there is the command stored in the command management table, the command being associated with the identification information.

The terminal device includes a communication unit configured to receive a command transmitted from the terminal management server, a connection unit configured to connect another terminal device, a command check transmission unit configured to transmit identification information for the terminal device, identification information for the other terminal device connected to the connection unit, and an acquisition request for a command to the terminal management server, and a command processing unit configured to transmit to the other terminal device connected to the connection unit a command for cancelling a restriction on the other terminal device when the command is received from the terminal management server.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF DRAWINGS

FIG. 1 is a pattern diagram illustrating a configuration of a terminal lock system according to the embodiment;

FIG. 2 is a block diagram illustrating an internal configuration of a terminal device;

FIG. 3 is a block diagram illustrating an internal configuration of a terminal management server;

FIG. 4 is a timing chart illustrating a flow of a processing operation performed at the time of terminal lock;

FIG. 5 is a timing chart illustrating a flow of a processing operation performed when the terminal lock is unlocked;

FIG. 6 is a timing chart illustrating a flow of a processing operation performed when the terminal lock is unlocked; and

FIG. 7 is a timing chart illustrating a flow of a processing operation performed when the terminal lock is unlocked.

### DESCRIPTION OF EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present.

Embodiments according to the present invention will be described with reference to the accompanying figures, hereinafter.

### First Embodiment

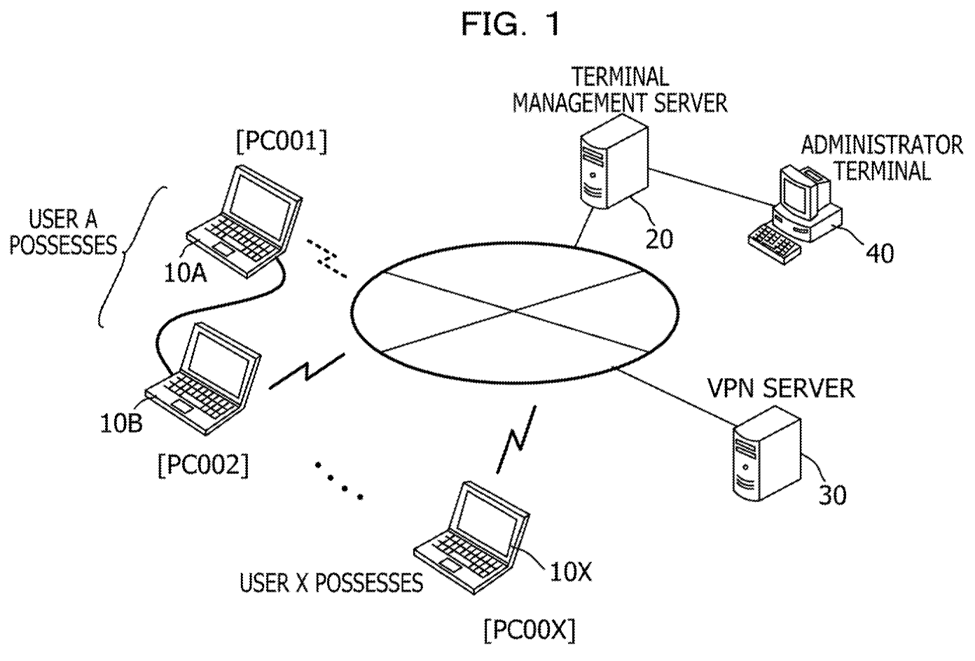

FIG. 1 is a pattern diagram illustrating the configuration of a terminal lock system according to the embodiment. The terminal lock system according to the embodiment includes a plurality of terminal devices 10A, 10B, and 10X, a terminal management server 20 for managing the plurality of terminal devices 10A, 10B, . . . , and 10X, and a VPN server 30. In addition, an administrator terminal 40 that an administrator of the terminal devices 10A to 10X uses is connected to the terminal management server 20.

The terminal devices 10A to 10X are, for example, notebook personal computers. In the embodiment, a user who works at a company can possess a plurality of terminal devices that the company supplies. User IDs for identifying users and terminal IDs for identifying the individual terminal devices are registered in the terminal management server 20, and hence the users of the individual terminal devices can be discriminated in the terminal management server 20.

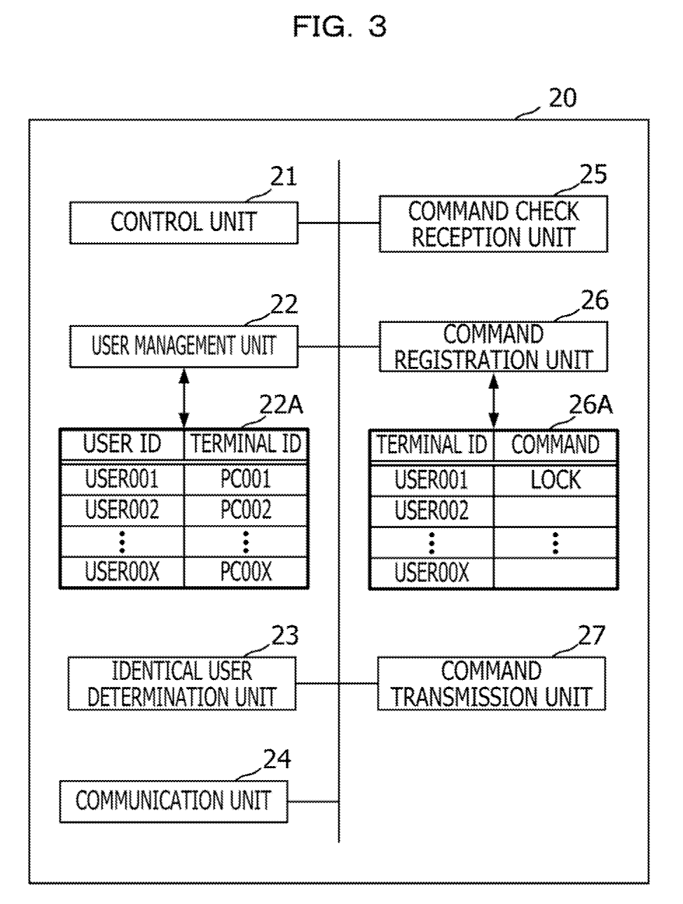

In the example illustrated in FIG. 1, it may be assumed that one user (user A) possesses the terminal device 10A and the terminal device 10B, and another user (user X) possesses the terminal device 10X. Here, it may be assumed that User001 and User00X are, as user IDs, assigned to the user A and the user X, respectively, and PC001, PC002, . . . , and PC00X are, as terminal IDs, assigned to the terminal device 10A, 10B, . . . and 10X, respectively. The user IDs and the terminal IDs are associated with one another, and are, as a user management table 22A, stored in the management server 20 (refer to FIG. 3).

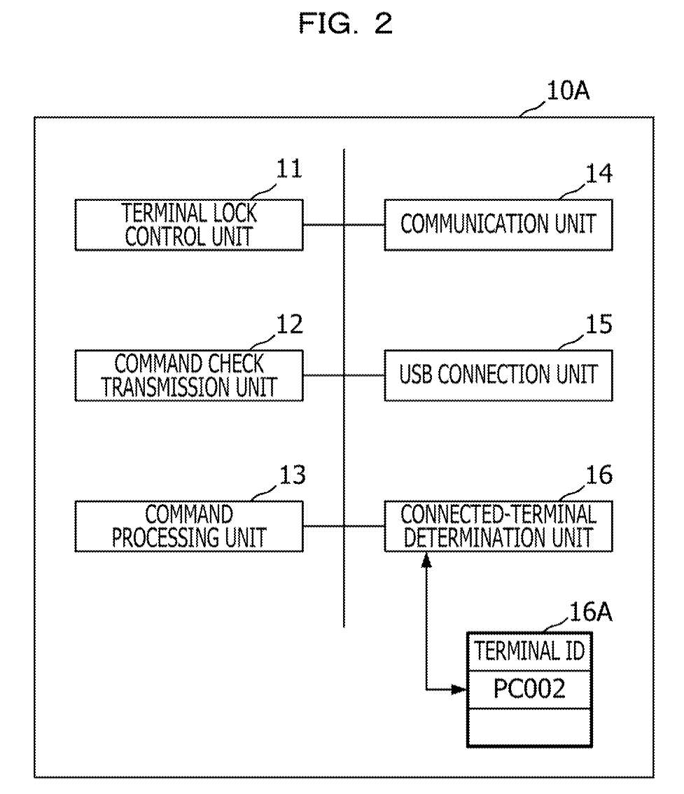

In addition, settings that terminal devices which an identical user possesses can be locally connected to one another are preliminarily set in the terminal devices. For example, in order to indicate that the terminal device 10B can be locally connected to the terminal device 10A that the user A possesses, the terminal device 10A includes a connected-terminal management table 16A in which “PC002” that is the terminal ID of the terminal device 10B is registered (refer to FIG. 2). In contrast, in order to indicate that the terminal device 10A can be locally connected to the terminal device 10B, the terminal device 10B includes a connected-terminal management table in which “PC001” that is the terminal ID of the terminal device 10A is registered.

The local connection mentioned above is, for example, universal serial bus (USB) connection as wired connection. When the USB connection is established, a usual USB connector cable is used.

While, in the embodiment, an example in which the terminal device 10A and the terminal device 10B are connected to each other using the USB connection will be described, the connection is not limited to the USB connection but a general wired connection used between terminal devices, such as a connection that uses serial bus, a connection that uses IEEE 1394, or the like, can be used. In addition to a wired connection, a near field communication such as Bluetooth (registered trademark) or the like may be used.

In addition, the individual terminal devices 10A to 10X include, for example, data communication cards, and hence can access the Internet through wireless communication. In addition, it may be assumed that the terminal devices 10A to 10X are unable to perform a SMS push to the data communication cards.

In addition, the terminal devices 10A to 10X are equipped with VPN software as software for securely connecting to a specific system such as an in-house system or the like. In a case in which the terminal devices 10A to 10X connect to a VPN server using the VPN software, when user authentication is performed, and the authentication succeeds, VPN sessions are established between the terminal devices 10A to 10X and the VPN server 30. While it is assumed that a user ID and a password are used at the time of VPN connection with respect to authentication information, the VPN server 30 may manage the authentication information, or an authentication server for managing the authentication information may be separately provided.

The VPN software with which the terminal device 10A to 10X are equipped are ready to be automatically executed immediately after the start-up thereof. When data communication can be performed after the start-up, a VPN connection is established first, and a command from the terminal management server 20 is checked. In addition, when there is a command, the command is immediately executed. Accordingly, for example, in a case in which the terminal devices 10A to 10X are remotely locked, when a third person other than a legitimate user tries to operate the terminal devices 10A to 10X after the power activation thereof, a terminal lock is immediately executed, thereby inhibiting an invalid operation from being performed.

In addition, unless the VPN connection and the establishment of connection with the terminal management server 20 succeed, the terminal devices 10A to 10X are not able to be operated, and hence an invalid operating performed in a PC located outside a radio wave range can also be substantially reduced or prevented.

FIG. 2 is a block diagram illustrating an internal configuration of the terminal device 10A. The terminal device 10A includes a terminal lock control unit 11, a command check transmission unit 12, a command processing unit 13, a communication unit 14, a USB connection unit 15, and a connected-terminal determination unit 16.

In the terminal lock control unit 11, a control program for performing a control operation relating to a terminal lock and terminal unlock is stored, and, by executing the control program in the terminal lock control unit 11, a processing operation relating to a terminal lock and terminal unlock is executed.

In order to request a command directed to the terminal device 10A itself, registered in the terminal management server 20, the command check transmission unit 12 transmits a command check request to the terminal management server 20. The terminal ID (PC001) of the terminal device 10A itself is included in the command check request. In addition, when the terminal device 10B that has the terminal ID (PC002) registered in the connected-terminal management table 16A is connected to the USB connection unit 15, the terminal ID (PC002) of the connected terminal device 10B is also included in the command check request, in addition to the terminal ID (PC001) of the terminal device 10A itself.

In a case in which the communication unit 14 receives a command transmitted from the terminal management server 20 in response to the command check request, when the received command is a command directed to the terminal device 10A itself, the command processing unit 13 executes a processing operation that corresponds to the received command. When the received command is a command that instructs to perform a terminal lock, the command processing unit 13 executes a processing operation relating to the terminal lock. When the terminal device 10A is subjected to a terminal lock, functions other than a function for communicating with the terminal device 10B that has the terminal ID (PC002) registered in the connected-terminal management table 16A are restricted, for example.

In addition, when the received command is a command that instructs to unlock a terminal lock, the command processing unit 13 executes a processing operation relating to the terminal unlock. At this time, a function subjected to a functional restriction due to the terminal lock is recovered.

In addition, when the received command is a command that is directed to the terminal device 10B connected to the terminal device 10A itself, the command processing unit 13 transmits the received command through the USB connection unit 15 to the terminal device 10B connected to the terminal device 10A itself.

In addition, when the command processing unit 13 receives a command, directed to the terminal device 10A itself, from the terminal device 10B that is another terminal device connected through the USB connection unit 15, the command processing unit 13 executes a processing operation that corresponds to the command received from the terminal device 10B that is the other terminal device.

The communication unit 14 includes a communication interface used for communicating with the VPN server 30 and the terminal management server 20.

The USB connection unit 15 includes an interface for wired-connecting with an external device through the USB connector cable. The connected-terminal determination unit 16 determines whether or not the external device connected to the USB connection unit 15 has a terminal ID registered in the connected-terminal management table 16A. When it is determined that the external device does not have the terminal ID, the external device is recognized as a general USB device. On the other hand, it is determined that the external device has the terminal ID, the external device is recognized as the terminal device 10B which the terminal device 10A allows to be connected to the terminal device 10A itself.

In FIG. 2, while the internal configuration of the terminal device 10A is described, the internal configurations of the terminal devices 10B to 10X are substantially similar as that of the terminal device 10A, and hence the descriptions thereof will be omitted. In this regard, however, it may be assumed that the terminal ID of a terminal device which the terminal device 10A allows to be connected to the terminal device 10A itself is registered in the connected-terminal management table 16A.

FIG. 3 is a block diagram illustrating the internal configuration of the terminal management server 20. The terminal management server 20 includes a control unit 21, a user management unit 22, an identical user determination unit 23, a communication unit 24, a command check reception unit 25, a command registration unit 26, and a command transmission unit 27.

The control unit 21 stores therein a control program used for performing a control operation relating to terminal management, and the control unit 21 executes the control program, thereby executing the control operation relating to terminal management.

The user management unit 22 includes a user management table 22A that stores therein a user ID and a terminal ID associating the user ID with the terminal ID. When a plurality of terminal IDs are included, as parameters, in a command check request from a terminal device, the identical user determination unit 23 determines, with reference to the registered contents of the user management table 22A, whether or not the users of terminal devices specified by the terminal IDs are the same user.

The communication unit 24 includes a communication interface used for communicating with the terminal devices 10A to 10X through a VPN.

The command check reception unit 25 receives command check requests from the terminal devices 10A to 10X through the communication unit 24. When receiving a command check request, the command check reception unit 25 checks, with reference to the command management table 26A in the command registration unit 26, whether or not there is a command associated with a terminal ID included in the command check request.

When there is the command associated with the terminal ID, the command transmission unit 27 reads out the command from the command management table 26A, and transmits the read out command through the communication unit 24 to the terminal device that has made the command check request.

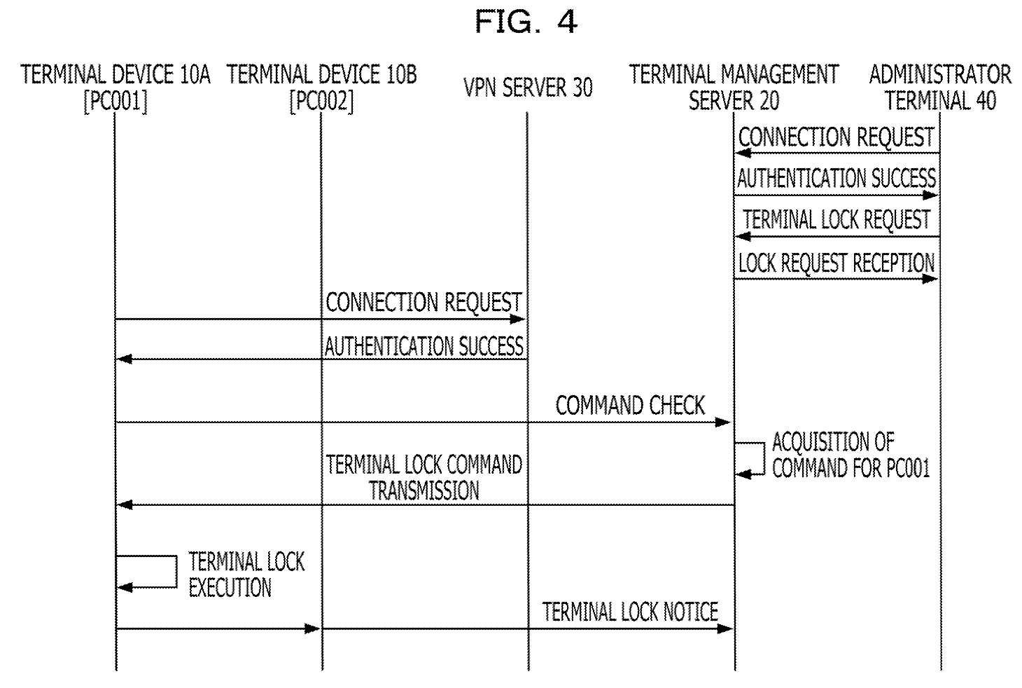

A flow of a processing operation performed at the time of a terminal lock will be described hereinafter. FIG. 4 is a timing chart illustrating the flow of the processing operation performed at the time of a terminal lock. For example, when the user A has taken the terminal device 10A out of the workplace, and has left the terminal device 10A at a business trip destination, the user A requests the administrator that administrates the terminal devices 10A to 10X to perform a terminal lock on the terminal device 10A.

The administrator who receives the request for a terminal lock operates the administrator terminal 40, and transmits a connection request to the terminal management server 20. At this time, the administrator terminal 40 receives the input of a user ID and a password, which are used for the administrator, and transmits the received user ID and password to the terminal management server 20.

When a connection is authenticated on the basis of the user ID and the password, transmitted from the administrator terminal 40, the terminal management server 20 transmits to the administrator terminal 40 a notice that the connection is authenticated.

The administrator terminal 40, whose connection to the terminal management server 20 is authenticated, receives the terminal ID (PC001) of the terminal device 10A so as to specify an object to be subjected to terminal lock, and transmits a terminal lock request to the terminal management server 20 along with the received terminal ID.

The terminal management server 20 that receives the terminal lock request specifies the object to be subjected to terminal lock, on the basis of the terminal ID, and registers a command, which is used for subjecting a corresponding terminal device (e.g., terminal device 10A) to a terminal lock, in the command management table 26A by associating the command with the terminal ID. When the command for terminal lock is registered, the terminal management server 20 transmits to the administrator terminal 40 a notice that the terminal lock request has been received.

At this time, the terminal device 10A has not been subjected to a terminal lock, and there is a risk that a third person may operate the terminal device 10A. Therefore, in a state in which the terminal device 10A is not powered on, the third person may power on the terminal device 10A. In addition, when an authentication screen is displayed at the time of a VPN connection, the third person may succeed in the VPN connection due to the setting of a simple authentication password. However, when, shortly thereafter, a command check operation is performed at the time of connecting to the terminal management server 20, the command used for a terminal lock has been registered, as a command to be transmitted to the terminal device 10A, in the command management table 26A. Accordingly, the terminal management server 20 acquires the command from the command management table 26A, and transmits the acquired command to the terminal device 10A.

When the terminal device 10A receives the command used for a terminal lock, transmitted from the terminal management server 20, the terminal lock control unit 11 in the terminal device 10A executes a terminal lock, and transmits to the terminal management server 20 a notice that the terminal lock has been executed. The terminal lock is realized by performing a functional restriction on the terminal device 10A. At this time, for example, functions other than a function for communicating with a device connected through the USB connection unit 15 are restricted (halted). Specifically, a function for receiving an arbitrary operation from a keyboard or the like, a function for displaying information on a display, a function for transmitting information to the outside through the communication unit 14, and the like are restricted, for example.

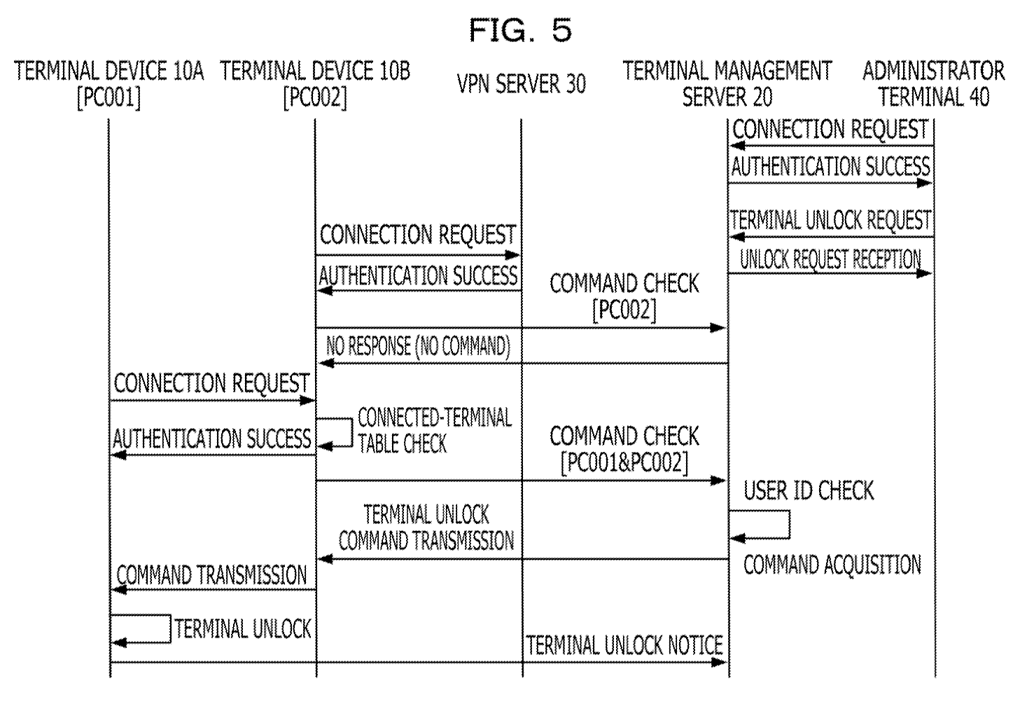

Next, a flow of a processing operation performed when a terminal lock is unlocked will be described. FIG. 5 is a timing chart illustrating the flow of the processing operation performed when a terminal lock is unlocked. When the user A who is a legitimate user of the terminal device 10A retrieves the terminal device 10A left, and unlocks the terminal lock of the terminal device 10A, the user A requests the administrator to perform a terminal unlock on the terminal device 10A, in substantially the same way as at the time of performing a terminal lock on the terminal device 10A.

The administrator who receives the request for a terminal unlock operates the administrator terminal 40, and transmits a connection request to the terminal management server 20. At this time, the administrator terminal 40 receives the input of a user ID and a password, which are used for the administrator, and transmits the received user ID and password to the terminal management server 20.

When a connection is authenticated on the basis of the user ID and the password, transmitted from the administrator terminal 40, the terminal management server 20 transmits to the administrator terminal 40 a notice that the connection is authenticated.

The administrator terminal 40, whose connection to the terminal management server 20 is authenticated, receives the terminal ID (PC001) of the terminal device 10A so as to specify an object to be subjected to a terminal unlock, and transmits a terminal unlock request to the terminal management server 20 along with the received terminal ID.

The terminal management server 20 that receives the terminal unlock request specifies the object to be subjected to terminal unlock, on the basis of the terminal ID, deletes a command used for a terminal lock, registered in the command management table 26A, and registers a command, which is used for a terminal unlock, in the command management table 26A associating the command with the terminal ID. When the command for a terminal unlock is registered, the terminal management server 20 transmits to the administrator terminal 40 a notice that the terminal unlock request has been received.

On the other hand, the user A starts up another terminal device, which is the terminal device 10B that the user A possesses. In preparation for connecting to the terminal management server 20, first, the terminal device 10B transmits a user ID and a password to the VPN server 30, and makes a connection request for a VPN. When the connection of the terminal device 10B to the VPN is authenticated, the VPN server 30 transmits to the terminal device 10B a notice that the connection has been authenticated.

At this time, when there is no terminal device locally connected to the terminal device 10B, the terminal device 10B checks whether or not a command directed to the terminal device 10B itself is registered in the terminal management server 20. While a command check result is returned from the terminal management server 20, the terminal device 10B does not execute an operation as a response to the command check if there is no command directed to the terminal device 10B itself.

In order to perform a terminal unlock on the retrieved terminal device 10A, the user A connects, using a USB connector cable, the terminal device 10A to the terminal device 10B that has been already started up.

The connected terminal device 10A transmits the terminal ID (PC001) thereof to the terminal device 10B, and makes a connection request.

When the terminal device 10B receives the terminal ID from the terminal device 10A connected to the terminal device 10B using USB, the terminal device 10B determines whether or not the terminal ID is a terminal ID registered in the connected-terminal management table 16A. When the terminal ID received along with the connection request is a terminal ID registered in the connected-terminal management table 16A, namely, the terminal ID of a terminal device which the terminal device 10B allows to be connected to the terminal device 10B itself, the terminal device 10B sends to the terminal device 10A a notice that the connection is authenticated.

Next, the terminal device 10B transmits to the terminal management server 20 a command check request along with the terminal ID (PC002) of the terminal device 10B itself and the terminal ID (PC001) of the terminal device 10A connected to the terminal device 10B, and checks whether or not there are a command directed to the terminal device 10B itself and a command directed to the terminal device 10A connected to the terminal device 10B.

The terminal management server 20 checks the terminal ID, received along with the command check request, against the user management table 22A, thereby determining whether or not the users of the two terminal devices are the same user. When the users of the two terminal devices are the same user, the terminal management server 20 determines whether or not there are commands stored associated with the terminal devices, respectively. When a corresponding command is stored in the command management table 26A, the terminal management server 20 transmits the command to the terminal device 10B that has made the command check request.

As described above, when the administrator is requested to perform a terminal unlock on the terminal device 10A, a command used for a terminal unlock is stored associated with the terminal ID of the terminal device 10A. Therefore, when the terminal device 10A subjected to a terminal lock is connected to the terminal device 10B, the terminal device 10B acquires the terminal ID of the terminal device 10A. In addition, by performing command check in place of the terminal device 10A, the terminal device 10B can acquire the command used for unlocking the terminal unlock of the terminal device 10A.

When the terminal device 10B receives the command used for unlocking the terminal unlock of the terminal device 10A from the terminal management server 20, the terminal device 10B transmits the received command to the terminal device 10A.

When the terminal device 10A receives the command transmitted from the terminal device 10B, the terminal device 10A performs a terminal unlock by executing the command, and recovers restricted functions. When the terminal unlock is completed, the terminal device 10A notifies the terminal device 10B and the terminal management server 20 of the completion of the terminal unlock.

The terminal management server 20 that receives the notice of the completion of the terminal unlock deletes the terminal unlock command directed to the terminal device 10A from the command management table 26A.

As described above, in the embodiment, in a case in which terminal unlock is executed for a terminal device under a terminal lock, a terminal device that is an object of the terminal unlock is connected to another terminal device, which normally functions and the user possesses, using a wired connection. In addition, the normally functioning terminal device can receive a command for the terminal device automatically connected to the normally functioning terminal device itself, in place of the connected terminal device, and transfer the received command to the terminal device under the terminal lock. Therefore, a problem that the terminal device under the terminal lock is unable to be operated and hence the terminal unlock is unable to be remotely performed can be averted.

In addition, since a user has the retrieved terminal device on hand, and the user himself can unlock the terminal lock of the terminal device, the workload of an administrator does not increase.

Since a normally functioning terminal device can connect to the terminal management server 20 after user authentication and terminal authentication succeed, security is secured. In addition, since a terminal device, wired-connected to the normally functioning terminal device using a USB cable or the like, is physically located near the normally functioning terminal device, it is substantially ensured that a legitimate user unlocks the terminal.

In a case in which, in the terminal management server 20, there are a plurality of terminal IDs that are objects of requests, when users corresponding to individual terminal IDs are the same user, the processing operation according to the present embodiment is permitted. Therefore, a third person is substantially prevented from controlling the user's terminal device without the user's permission.

In addition, in the embodiment, the configuration is adopted in which, at the time of a terminal unlock, the terminal management server 20 determines whether or not a user is an identical user, and then a command directed to an object of the terminal unlock is checked. However, for example, a configuration may be adopted in which a terminal unlock is permitted when a terminal device that is an object of terminal unlock is connected to a terminal device belonging to the same group. In this case, the terminal management server 20 may store therein terminal IDs associating the terminal IDs with a group ID that identifies the group, and the terminal management server 20 may determine whether or not a terminal device is connected to another terminal device belonging to the same group when a request for a terminal unlock is received.

In addition, in the embodiment, the configuration is adopted in which terminal devices (for example, the terminal devices 10A and 10B), which can be locally connected to each other and the same user possesses, register therein each other's terminal IDs. However, a configuration may be adopted in which one terminal device registers therein the terminal ID of a terminal device that is an object for a connection, and the other terminal device does not register therein the terminal ID of a connection destination. For example, when one user possesses a terminal device (desktop personal computer) used as a main machine and a terminal device (notebook personal computer) used as a sub-machine, a configuration may be adopted in which the terminal ID of the sub-machine is registered in the main machine, and the terminal ID of a connection destination is not registered in the sub-machine.

### Second Embodiment

While, in the first embodiment, the configuration is adopted in which all functions are recovered in response to a command for a terminal unlock, a configuration may be adopted in which functions are partly recovered in response to a command for a terminal unlock. In the embodiment, a configuration will be described in which the communication function of the terminal device is recovered at the time of a terminal unlock, and a restriction is canceled so that the terminal device functions as a VPN client and a terminal management client.

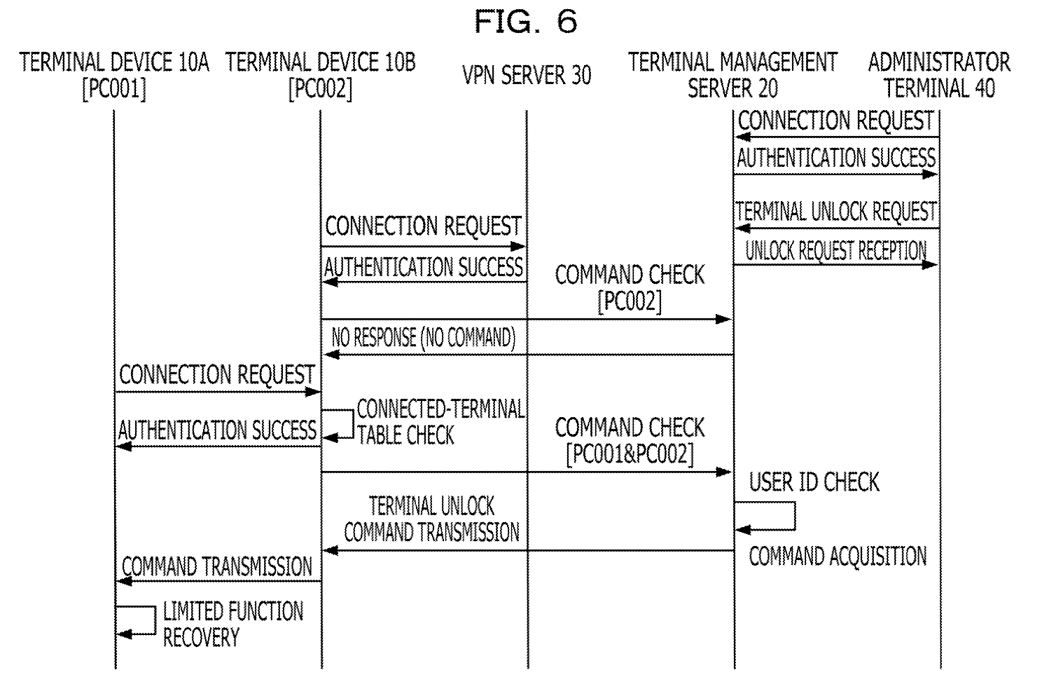

FIG. 6 is a timing chart illustrating a flow of a processing operation performed when a terminal lock is unlocked. A flow of a processing operation will be described, the processing operation being performed when the terminal device 10A that the user A possesses is subjected to a terminal lock, the terminal device 10A subjected to the terminal lock is connected to the terminal device 10B that is another terminal device that the user A possesses, and the terminal unlock of the terminal device 10A is performed.

In substantially the same way as in the first embodiment, by requesting the administrator of the device to perform a terminal unlock, the user A has a command, used for unlocking the terminal device 10A, registered in the command management table 26A in the terminal management server 20.

Next, the user A connects the terminal device 10A to the terminal device 10B, using a USB connector cable. When checking whether or not there is a command directed to the terminal device 10B itself, the terminal device 10B also acquires a command directed to the terminal device 10A from the terminal management server 20 by causing the terminal ID of the terminal device 10A connected to the terminal device 10B itself to be included. The command used for a terminal unlock, which the terminal device 10B acquires and is directed to the terminal device 10A, is transmitted to the terminal device 10A. In addition, the flow of the processing operation that has been performed so far is substantially the same as in the first embodiment.

When receiving the command used for a terminal unlock from the terminal device 10B, the terminal device 10A performs the recovery of functions in a limited way. At this time, by recovering a communication function performed by the communication unit 14, the terminal device 10A causes the communication unit 14 to function as a VPN client and a terminal management client, and cancels a restriction so as to communicate with the VPN server 30 and the terminal management server 20.

In this way, the terminal device 10A can be caused to be connected to the terminal management server 20 through the connection authentication of the VPN server 30, based on a legitimate user. When connection authentication based on the VPN server 30 is obtained, the terminal device 10A can be connected to the terminal management server 20. Therefore, all functions can be recovered by directly acquiring the command used for a terminal unlock from the terminal management server 20.

In addition, when the terminal device 10B receives, in place of the terminal device 10A, a terminal unlock directed to the terminal device 10A, the terminal device 10B does not send a terminal unlock notice to the terminal management server 20. Accordingly, the terminal management server 20 can keep the terminal device 10A in a state that the terminal device 10A does not succeed in a terminal unlock.

In the second embodiment, in a case in which a terminal device is connected to another terminal device, and a terminal unlock is performed, the terminal unlock is not completely permitted in this state but, after the user succeeds again in authentication by inputting authentication information, the terminal device is connected to the terminal management server 20, and the terminal unlock is executed. Accordingly, a risk of an illegal operation for a terminal unlock can be reduced.

### Third Embodiment

While, in the first embodiment, the configuration is adopted in which the terminal lock of a terminal device connected using a USB connector cable is unlocked, a configuration may be adopted in which, for example, a connection that uses near field communication such as Bluetooth or the like is also permitted, and the range of recovered functions differs according to the kind of a communication method. In the embodiment, as an example of the configuration in which the range of recovered functions differs according to the kind of a communication method, a configuration will be described in which all functions are recovered when a wired connection such as a USB connector cable is used, and some of functions are recovered when a connection is based on near field communication such Bluetooth or the like.

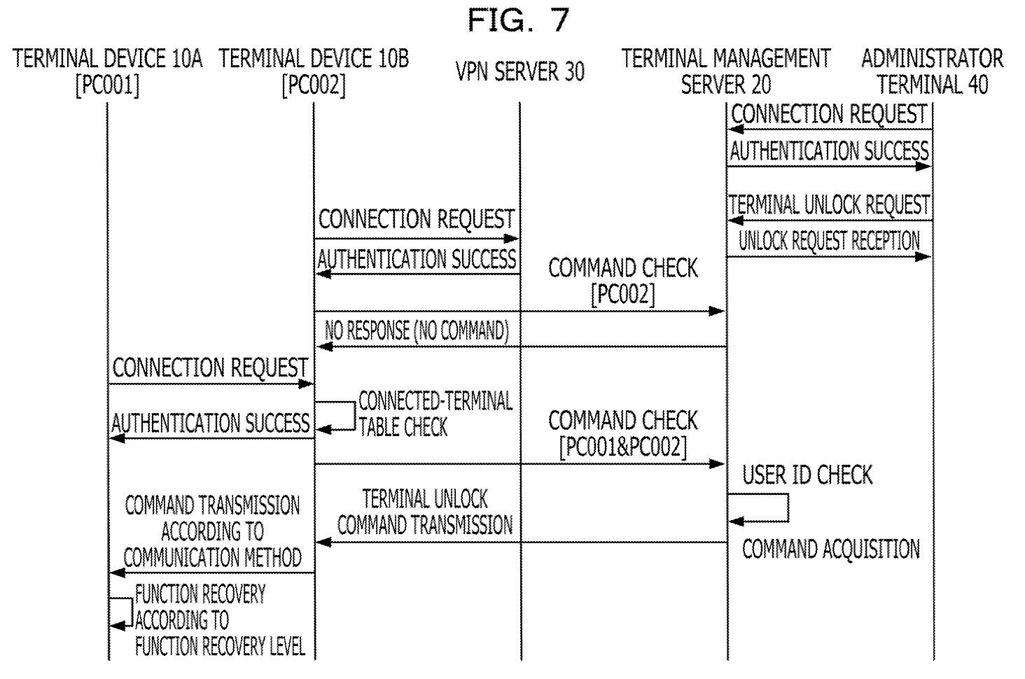

FIG. 7 is a timing chart illustrating a flow of a processing operation performed when a terminal lock is unlocked. A flow of a processing operation will be described, the processing operation being performed when the terminal device 10A that the user A possesses is subjected to a terminal lock, the terminal device 10A subjected to the terminal lock is connected to the terminal device 10B that is another terminal device that the user A possesses, and the terminal unlock of the terminal device 10A is performed.

In substantially the same way as in the first embodiment, by requesting the administrator of the device to perform a terminal unlock, the user A has a command, used for unlocking the terminal device 10A, registered in the command management table 26A in the terminal management server 20.

Next, the user A connects the terminal device 10A to the terminal device 10B, using a USB connector cable or near field communication such as Bluetooth or the like. When checking whether or not there is a command directed to the terminal device 10B itself, the terminal device 10B also acquires a command directed to the terminal device 10A from the terminal management server 20 by causing the terminal ID of the terminal device 10A connected to the terminal device 10B itself to be included.

The terminal device 10B determines whether or not a communication method used for communicating with the connected terminal device 10A is communication based on USB or near field communication such as Bluetooth or the like. When the communication method used for communicating with the connected terminal device 10A is the communication based on USB, the terminal device 10B transmits to the terminal device 10A a terminal unlock command in which the recovery level of a functional restriction is set to all functions. In the terminal device 10A that receives the terminal unlock command, the command processing unit 13 executes the command, thereby recovering the all functions.

On the other hand, when the communication method used for communicating with the connected terminal device 10A is the near field communication, the terminal device 10B transmits to the terminal device 10A a terminal unlock command in which the recovery level of a functional restriction is limited to a communication function performed by the communication unit 14. Since the terminal device 10A that receives the terminal unlock command is in a state in which the communication function performed by the communication unit 14 is recovered, the terminal device 10A can be caused to be connected to the terminal management server 20 through the connection authentication of the VPN server 30, in substantially the same way as in the second embodiment. When connection authentication based on the VPN server 30 is obtained, the terminal device 10A can be connected to the terminal management server 20. Therefore, all functions can be recovered by directly acquiring the command used for a terminal unlock from the terminal management server 20.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

What is claimed is:

1. A terminal management system comprising:
a terminal management server including;
a communication unit configured to communicate with a plurality of terminal devices,
a command registration unit configured to store a command in a command management table associated with identification information for a terminal device, the command being used to restrict a function of the terminal device or cancel a restriction on a function of the terminal device,
a command check reception unit configured to receive identification information for a terminal device and an acquisition request for a command, transmitted from the terminal device, and configured to determine whether there is a command stored in the command management table, the command being associated with the received identification information for the terminal device, and
a command transmission unit configured to transmit the command to a terminal device that is a transmission source of the acquisition request when it is determined that there is the command stored in the command management table, the command being associated with the identification information, and
a terminal device including;
a communication unit configured to receive a command transmitted from the terminal management server;
a connection unit configured to connect another terminal device,
a command check transmission unit configured to transmit identification information for the terminal device, identification information for the other terminal device connected to the connection unit, and an acquisition request for a command to the terminal management server, and
a command processing unit configured to transmit to the other terminal device connected to the connection unit a command for cancelling a restriction on the other terminal device when the command is received from the terminal management server.

2. The terminal management system according to claim 1, wherein
the terminal management server further includes,
a user management unit configured to store identification information for terminal devices and user identification information for users of the terminal devices in a user management table and associate the identification information for the terminal device with the identification information for the users; and
an identical user determination unit configured to determine, based on the user identification information stored in the user management table, whether the users of the terminal devices that correspond to the received identification information for the plurality of terminal devices are the same user,
wherein
the command check reception unit determines whether there is the command when it is determined that the users of the plurality of terminal devices are the same user.

3. The terminal management system according to claim 2, wherein
the terminal device further includes,
a terminal lock control unit configured to restrict at least a function for communicating with the terminal management server or cancel a restriction on at least the function for communicating with the terminal management server, in accordance with a command from the terminal management serve;
a recovery function configured to recover the function for communicating with the terminal management server when a command for cancelling a restriction is received at the time the restriction is imposed on the function; and
a user information transmission unit configured to transmit user identification information to the terminal management server, and
the terminal management server includes
a user information reception unit configured to receive the user identification information transmitted from the terminal device; and
an authentication unit configured to perform user authentication on the basis of the received user identification information and transmit an authentication result to the terminal device,
wherein
the terminal lock control unit in the terminal device recovers another function, restricted, when an authentication result that a user is authenticated on the basis of the user authentication performed by the terminal management server is received.

4. The terminal management system according to claim 1, wherein
a function, a restriction on which is to be cancelled when the terminal device receives a command for cancelling the restriction, is determined in accordance with a communication method for communicating with the other terminal device connected.

5. The terminal management system according to claim 4, wherein
the communication methods are communication, which uses a wired connection, and near field communication.

6. A terminal management server comprising:
a communication unit configured to communicate with a plurality of terminal devices;
a command registration unit configured to store a command in a command management table associated with identification information for a terminal device, the command being used to restrict a functions of the terminal device or cancel a restriction on a functions of the terminal device;
a command check reception unit configured to receive identification information for a terminal device and an acquisition request for a command, transmitted from the terminal device, and configured to determine whether there is a command stored in the command management table, the command being associated with identification information for the terminal device, when an acquisition request for the identification information and the command is received; and
a command transmission unit configured to transmit the command to a terminal device that is a transmission source of the acquisition request when it is determined that there is the command stored in the command management table, the command being associated with the identification information.

7. A terminal device comprising:
a communication unit configured to receive a command from the outside;
a connection unit configured to connect another terminal device;
a command transmission unit configured to transmit identification information for the terminal device, identification information for the other terminal device connected to the connection unit, and an acquisition request for a command to the outside; and
a command processing unit configured to transmit to the other terminal device connected to the connection unit a command for cancelling a restriction on a function of the other terminal device when the command is received.

8. The terminal device according to claim 7, further comprising:
a terminal lock control unit configured to restrict at least a function for communicating with the outside or cancel a restriction on at least the function for communicating with the outside, in accordance with the received command;
a recovery function configured to recover a function for communicating with the outside when a command for cancelling a restriction is received at the time the restriction is imposed on the function; and
a user information transmission unit configured to transmit user identification information to the outside, and
wherein
another function, restricted, is recovered when a user is authenticated using the transmitted user identification information.

9. The terminal device according to claim 7, wherein
a function, a restriction on which is to be cancelled when a command for cancelling the restriction is received, is determined in accordance with a communication method for communicating with the other terminal device connected.

10. The terminal device according to claim 9, wherein
the communication methods are communication, which uses a wired connection, and near field communication.

11. A computer readable storage medium which stores a program to make a computer, in which identification information for each communication device is stored, to execute a process comprising:
storing a command with associating the command with identification information for a terminal device, the command being used for restricting some of functions of the terminal device or cancelling a restriction on some of functions of the terminal device;
determining whether or not there is a command, stored with being associated with identification information for one terminal device or a plurality of terminal devices, when an acquisition request for the identification information and the command is received form one communication device; and
transmitting the command to the communication device that transmits the acquisition request, when there is the command stored with being associated with the identification information.

12. A computer readable storage medium which stores a program to make a computer to execute a process comprising:
restricting some of functions or cancelling a restriction on some of functions in accordance with a command acquired from the outside;
determining whether or not an external device is connected;
determining whether or not some of functions of the connected external device are restricted;
transmitting identification information for the self-device, identification information for the external device, and an acquisition request for a command to the outside when it is determined that some of functions of the external device are restricted; and
when a command used for cancelling a restriction on the external device is received from the outside, transmitting the acquired command to the external device.
